(19) United States
(12) Patent Application Publication
(10) Pub. No.: US 2025/0336994 A1
(43) Pub. Date: Oct. 30, 2025

(54) METHOD FOR A COMPRESSOR ARRANGEMENT FOR A VEHICLE WITH A FUEL CELL SYSTEM

(71) Applicant: ZF CV Systems Global GmbH, Bern (CH)

(72) Inventor: Janik Ricke, Uetze-Eltze (DE)

(21) Appl. No.: 19/263,085

(22) Filed: Jul. 8, 2025

Related U.S. Application Data
(63) Continuation of application No. PCT/EP2024/050108, filed on Jan. 3, 2024.

(30) Foreign Application Priority Data
Jan. 13, 2023 (DE) 10 2023 100 746.7

(51) Int. Cl. H01M 8/04746; H01M 8/0432; H01M 8/04992

(52) U.S. Cl. CPC H01M 8/04768; H01M 8/04358; H01M 8/04992; H01M 2250/20

(57) ABSTRACT

A method is for a compressor arrangement for a vehicle, in particular a commercial vehicle. The method includes: detecting a temperature of air to be compressed, barometric information relating to the air, and a rotating speed of the compressor arrangement and a performance variable of the compressor arrangement; determining an operating point as a function of the rotating speed and/or of the performance variable; determining an offer-related point adjustable as a potential operating point as a function of the operating point, of the temperature and of the barometric information; ascertaining offer-related information as a function of the operating point and of the offer-related point; and outputting the offer-related information.

### CROSS-REFERENCE TO RELATED APPLICATIONS

This application is a continuation application of international patent application PCT/EP2024/050108, filed Jan. 3, 2024, designating the United States and claiming priority from German application 10 2023 100 746.7, filed Jan. 13, 2023, and the entire content of both applications is incorporated herein by reference.

### TECHNICAL FIELD

The present disclosure relates to a method for a compressor arrangement for a vehicle, in particular a commercial vehicle. The disclosure also relates to a computer program and/or a computer-readable medium, to a control apparatus for a compressor arrangement for a vehicle, in particular a commercial vehicle, to a compressor arrangement for a vehicle, in particular a commercial vehicle, including a control apparatus having a signal interface, to a fuel cell system for a vehicle, in particular a commercial vehicle, and to a vehicle, in particular a commercial vehicle.

The disclosure relates in particular to a compressor arrangement for a fuel cell vehicle, thus to a vehicle, in particular a commercial vehicle, which has a fuel cell system having the compressor arrangement and a fuel cell assembly, wherein the compressor arrangement is configured to impinge a cathode of the fuel cell assembly with an air flow.

### BACKGROUND

According to the prior art, compressor arrangements of this type, or compressors of fuel cells, are reactively feedback-controlled. This means that the fuel cell system and/or any other control apparatus defines for the compressor arrangement a mass flow that is to be conveyed through the compressor arrangement. Thereupon, the compressor increases or decreases a rotating speed until an air mass sensor has detected the requested mass flow. If a map of the compressor arrangement, from which a correlation between the mass flow and the rotating speed is able to be derived, is stored in the fuel cell system, or the control apparatus, the control apparatus can define directly the rotating speed of the compressor.

In reactive feedback-control of this type, it is not deliberately possible to carry out a wear-optimized or at least wear-improving operating strategy, because only the mass flow is defined as a setpoint value which is then to be set as quickly as possible by the compressor arrangement. However, since a buffer battery is installed in a typical fuel cell system, many dynamic applications are not at all necessary. In this way, load cycles of the compressor arrangement, which are not relevant, or only relevant to a minor extent, to the operation of the vehicle, in particular of the commercial vehicle, but imply wear on the compressor arrangement, can be induced by the reactive feedback-control. Furthermore, energy has to be expended for the load cycles, a reduction of the load cycles thus potentially leading to an improvement in the efficiency of the compressor arrangement and thus to more effective operation of the compressor arrangement.

### SUMMARY

It is an object of the present disclosure to specify an improved method which is suitable to enrich the prior art. A specific configuration embodiment of the disclosure can achieve the object of enabling an improved operating strategy of a compressor arrangement, by way of which improved operation of the compressor arrangement with less wear can be achieved.

The object is achieved by various embodiments of the disclosure.

Provided according to an aspect of the disclosure is a method for a compressor arrangement for a vehicle, in particular a commercial vehicle. The method here includes: detecting a temperature of air to be compressed and of barometric information relating to the air and a rotating speed of the compressor arrangement and/or a performance variable of the compressor arrangement; determining an operating point as a function of the rotating speed and/or of the performance variable; determining an offer-related point adjustable as a potential operating point as a function of the operating point, of the temperature and of the barometric information; ascertaining offer-related information as a function of the operating point and of the offer-related point; and outputting the offer-related information.

The barometric information here can be, for example, a height above sea level and/or the air pressure, wherein the air pressure is able to be ascertained from the height. It has been recognized that the temperature and the air pressure can be decisive for the performance reserves and thus for the feedback-control of the compressor arrangement. The temperature and the barometric information are variables which can characterize the air to be compressed by the compressor arrangement. The rotating speed can be an actual rotating speed, and/or the performance variable, for example a conveyed quantity, thus the mass flow, a volumetric flow and/or a drive performance, can be an actual performance variable. The performance variable of the compressor arrangement can be able to be derived from the rotating speed, and vice versa, in order to characterize the operating point of the compressor arrangement.

The operating point can indicate the actual operating state of the compressor arrangement. The operating point can be ascertained here by the rotating speed characterizing the operation of the compressor arrangement, and/or from the performance variable, and can characterize the mass flow able to be generated by the compressor arrangement.

Proceeding from the ascertained operating point, an offer-related point can be ascertained, which is characterized by, for example, a maximum achievable mass flow through the compressor arrangement, a maximum pressure ratio achievable by the compressor arrangement and/or a rotating speed achieving the maximum mass flow and/or the maximum pressure ratio. Thus, the offer-related point can potentially be considered an operating point by the compressor arrangement. The offer-related point thus describes a feedback-control reserve of the compressor arrangement, thus a range of parameters which can be achievable for the compressor arrangement.

Owing to the operating point and the offer-related point, the offer-related information can be output based on the feedback-control reserve of the compressor arrangement. It has been recognized here that the compressor arrangement can be able to be operated more effectively and with less wear when the offer-related information relating to the operating of the compressor arrangement is ascertained and output, because a change from the operating point to the offer-related point may be associated with a load cycle and thus with wear. The offer-related information output can be taken into account, for example, when controlling the compressor arrangement in an open-loop and/or closed loop, so as to minimize the load cycle and to thus minimize the wear on the compressor arrangement. In this way, reactive feedback-controlling of the compressor arrangement can be exceeded, because a demand for a mass flow, or a “request” for air, can be configured so as to be less dynamic in the proposed operating strategy for the compressor arrangement.

Optionally, the offer-related information has a mass flow achievable at the offer-related point, a pressure ratio achievable at the offer-related point and/or a rotating speed relating to the offer-related point. It has been recognized here that by changing the operating point, a different mass flow, a different pressure ratio and/or a different rotating speed is actuatable, in each case in comparison to the operating point. In this way, the offer-related information includes characteristic data relating to the compressor arrangement.

Optionally, determining the offer-related point takes place via a map of the compressor arrangement. The map characterizes the operation of the compressor arrangement at a given temperature and pressure and indicates a dependency between the pressure ratio and the mass flow at a given rotating speed. Observing a plurality of rotating speeds thus results in the map as a two-dimensional area which can be stored in a control apparatus. In this way, proceeding from any arbitrary operating point, the offer-related point can be effectively ascertained.

Optionally, the offer-related information is ascertained as a function of a rotating speed difference and/or of a performance variable difference. In other words, the offer-related information indicates a spacing between an actual mass flow and a maximum mass flow and/or a spacing between an actual pressure ratio and a maximum pressure ratio. The spacings can be stored as values in a manner accessible for the control apparatus in order to ascertain the offer-related information. The pressure ratio and the mass flow here are not mutually independent, but follow rotating speed curves in a map. In this way, the offer-related information for, for example, a fuel cell control apparatus can include relevant variables for operating a fuel cell arrangement.

Optionally, the method includes: ascertaining a feedback-control period as a function of the operating point and of the offer-related point, wherein the offer-related information includes the feedback-control period. A temporal component for feedback-controlling the compressor arrangement can be added by way of the feedback-control period. Proceeding from the operating point, the feedback-control period can relate to the period in which the offer-related point can be achieved, for example until achieving a maximum performance variable, in particular an inverter performance, thus a performance of power electronics for driving the compressor arrangement.

Optionally, the feedback-control period includes a buffer period. In this way, a temporal buffer component can be provided in order to preserve the components of the compressor arrangement. This means that the buffer period can be added as from the minimum time in which the compressor arrangement is capable of achieving the offer-related point. Alternatively, the buffer period can be constant. A buffer time ensures that the compressor arrangement is operated with less dynamics and thus load cycles are reduced and components are preserved.

Optionally, the buffer period is a function of an operating variable and/or operating temperature of the compressor arrangement. Furthermore optionally, the buffer period can also be made a function of the operating variable and/or the operating temperature. For example, when the compressor arrangement is operated at a performance limit of the power electronics of the compressor arrangement as an operating variable and/or at a thermal limit, the buffer period can be chosen larger. In this way, it is avoided that a lining on a bearing for a rotor of the compressor arrangement detaches at high temperatures. A heavy acceleration, or a load cycle, which may promote wear, is avoided.

Optionally, the offer-related information is ascertained while taking into account a buffer factor. In other words, the buffer factor can be integrated as a safety factor into the offer-related information. The safety factor can be taken into account for the offer-related function, so as to consider the offer-related information as subject to uncertainty and not any value of the offer-related information without making requestable, or offering, the buffer factor. For example, when the offer-related information indicates a mass flow of 200 g/s as a performance variable and this at the same time represents the choke line of the compressor arrangement, this offer-related information could be reduced by 10% as a buffer factor, so as to define a safety limit and not to operate the compressor arrangement at the choke line. Optionally, after reaching a parameter regime subject to uncertainty, for example above the safety limit, the compressor arrangement can become reactive.

Optionally, the vehicle, in particular the commercial vehicle, includes a fuel cell assembly, and the compressor arrangement is configured to impinge the fuel cell assembly with an air flow. In this way, the method can be provided for a compressor arrangement in which wear due to load cycles can be particularly effectively avoided.

Provided according to an aspect of the disclosure is a computer program and/or computer-readable medium including commands which, when the program or the commands is/are executed by a computer, initiate the latter to carry out the above-described method and/or the steps of the method. Optionally, the computer program and/or computer-readable medium includes commands which, when the program or the commands is/are executed by a computer, initiate the latter to implement one or a plurality of optional features of the above-described method in order to achieve an associated technical effect.

Provided according to an aspect of the disclosure is a control apparatus for a compressor arrangement for a vehicle, in particular a commercial vehicle. The control apparatus is configured to carry out the above-described method, and has a signal interface for outputting the offer-related information. Optionally, the control apparatus is configured to implement one or a plurality of optional features of the above-described method in order to achieve an associated technical effect.

Provided according to an aspect of the disclosure is a compressor arrangement for a vehicle, in particular a commercial vehicle, including the above-described control apparatus having a signal interface.

Provided according to an aspect of the disclosure is a fuel cell system for a vehicle, in particular a commercial vehicle. The fuel cell system includes the above-described compressor arrangement, a fuel cell control apparatus and a fuel cell assembly, wherein the compressor arrangement is configured to impinge the fuel cell assembly with an air flow, and the signal interface is configured to output the offer-related information to the fuel cell control apparatus.

Provided according to an aspect of the disclosure is a vehicle, in particular a commercial vehicle, including the above-described compressor arrangement and/or the above-described fuel cell system. Additionally or alternatively, the vehicle, in particular the commercial vehicle, can include a pneumatically activatable braking device, and the compressor arrangement can include a piston compressor and be configured to impinge the braking device of the vehicle, in particular of the commercial vehicle, with an air flow.

### BRIEF DESCRIPTION OF DRAWINGS

The invention will now be described with reference to the drawings wherein:

FIG. 1 schematically shows a vehicle, in particular a commercial vehicle, according to an aspect of the disclosure;

FIG. 2 schematically shows a map having an operating point and an offer-related point for operating a compressor arrangement according to an aspect of the disclosure; and,

FIG. 3 schematically shows a flow chart of a method according to an aspect of the disclosure.

### DETAILED DESCRIPTION

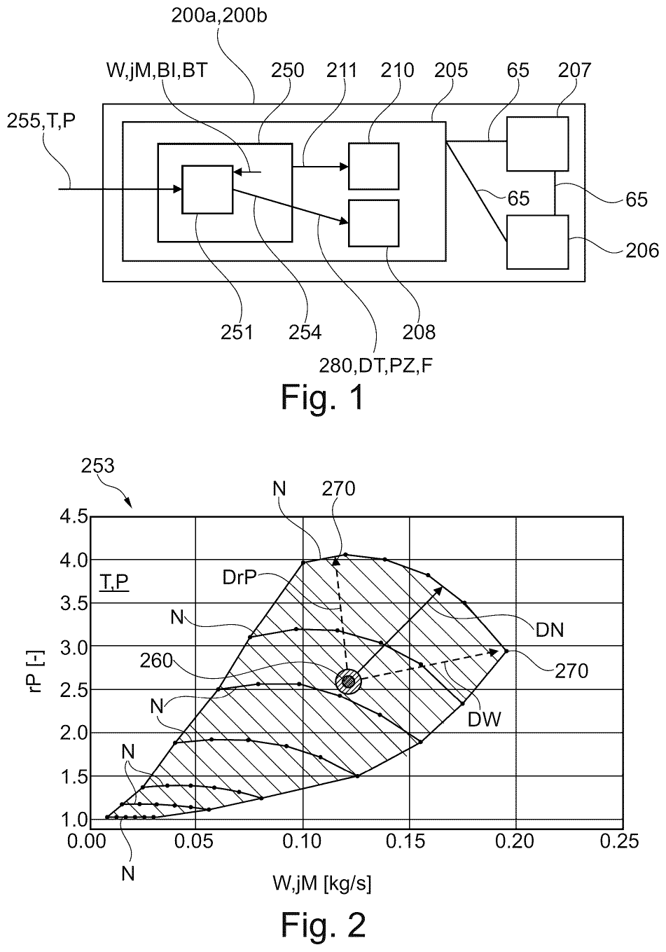

FIG. 1 schematically shows a vehicle 200a, in particular a commercial vehicle 200b, according to an aspect of the disclosure.

The vehicle 200a, in particular the commercial vehicle 200b, is referred to hereunder as vehicle 200a, 200b. The vehicle 200a, 200b is, for example, an overland vehicle, a watercraft and/or an aircraft.

The vehicle 200a, 200b has a fuel cell system 205, an energy storage device 206, for example a traction battery, and an electric drive 207. The fuel cell system 205 is configured to provide electric energy 65 to the energy storage device 206. The energy storage device 206 is, for example, a rechargeable energy storage device 206 and serves as a buffer battery for buffering electric energy 65. The energy storage device 206 is connected to the electric drive 207 so as to supply the electric drive 207 with electric energy 65, so that the electric drive 207 can drive the vehicle 200a, 200b. Additionally, the fuel cell system 205 is connected to the electric drive 207 in order to directly provide electric energy 65.

The fuel cell system 205 includes a compressor arrangement 250, a fuel cell control apparatus 208 and a fuel cell assembly 210.

The compressor arrangement 250 includes one or more compressors (not shown) and a control apparatus 251. The control apparatus 251 is configured to control the compressors, or the compressor arrangement 250. The control apparatus 251 of the compressor arrangement 250 includes power electronics (not shown) for impinging an electric drive of the compressor arrangement 250 for driving the compressor arrangement 250. The compressor arrangement 250 is configured to draw in air 255 and to impinge the fuel cell assembly 210 with an air flow 211 on the cathode side.

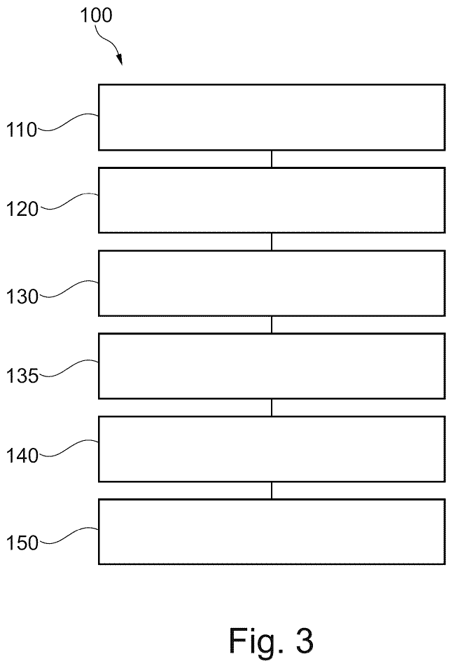

The control apparatus 251 is configured to carry out the method 100 according to FIG. 3. For this purpose, the control apparatus 251 according to FIG. 1 has a signal interface 254. The signal interface 254 is configured to output offer-related information 280 to the fuel cell control apparatus 208. The signal interface 254 can be a fieldbus interface, for example a CAN interface, and/or an interface for wireless communication, for example via Bluetooth, and/or a wireless local network (WLAN).

The control apparatus 251 is configured to receive by way of a CAN bus and/or a wireless communication interface an absolute vehicle height above sea level as barometric information P and the ambient air temperature as the temperature T. Temperature sensors are present in vehicles in order to detect the temperature T. The barometric information P is able to be read as height by way of topographical information and/or by way of a pressure sensor. The barometric information P and the temperature T have an influence on properties of the air 255 to be drawn in and thus on the “performance reserve” of the compressor arrangement 250. At great heights, a suction pressure of the compressor arrangement 250 is less, meaning that only a smaller absolute pressure, or output pressure, is achieved by a specific pressure ratio rP. In this way, more energy for compression has to be expended by the compressor arrangement 250 at a given demand for the absolute pressure. More energy is required for compressing warm air 255 than for compressing cold air. Alternatively, a height and temperature T, or their influence on compression, can be estimated by way of the electric power consumption of the inverter, the pressure P and the mass flow jM.

The compressor arrangement 250 has a rotating speed sensor (not shown) and/or is configured for sensor-less rotating speed detection, so as to ascertain a rotating speed N of the compressor arrangement 250, or of a rotor of the compressor arrangement 250, respectively. The sensor-less rotating speed detection here can take place by the power electronics. The control apparatus 250 is configured to detect the rotating speed N of the compressor arrangement 250 and a performance variable W of the compressor arrangement 250. The performance variable W is, for example, a mass flow jM which quantitatively indicates a flow of the air flow 211. In this way, the performance variable W indicates a delivery output of the compressor arrangement 250. The control apparatus 251 detects the temperature T, the height above sea level, or directly an air pressure as the barometric variable P, a rotating speed N as actual rotating speed and the performance variable W. The performance variable W can be ascertained from the rotating speed N and a volumetric flow as an aerodynamic performance and/or via a mechanical performance on a shaft, or on the rotor of the compressor arrangement 250.

The control apparatus 251 has a memory (not shown) for storing data. A map 253 (see FIG. 2) of the compressor arrangement 250 is stored on the control apparatus 251, or in the memory.

The control apparatus 251 is configured to determine an operating point 260 (see FIG. 2) as a function of the rotating speed N and of the performance variable W. The detected data are processed in order to determine the operating point 260 in the map 253 of the compressor arrangement 250. The control apparatus 251 is configured to determine an offer-related point 270 adjustable as a potential operating point 260 as a function of the operating point 260, of the temperature T and of the barometric information P. For this purpose, the control apparatus 251 is configured to detect an operating variable BI and/or operating temperature BT of the compressor arrangement 250. The operating variable BI describes, for example, the power consumption of the electric drive of the compressor arrangement 250. The operating temperature BT describes the temperature of the compressor arrangement 250 and/or of a component thereof.

The operating point 260 and the offer-related point 270 and a correlation between the operating point 260 and the offer-related point 270 are described in more detail with reference to FIG. 2.

The control apparatus 251 according to FIG. 1 is configured to determine offer-related information 280 with a feedback-control period DT, including a buffer period PZ and a buffer factor F, as a function of the operating point 260 and of the offer-related point 270. The offer-related information 280 has a mass flow jM achievable at the offer-related point 270 and/or a pressure ratio rP achievable at the offer-related point 270.

The control apparatus 251 is configured to transmit the offer-related information 280 via the signal interface 254 to the fuel cell control apparatus 208. The offer-related information 280 can be transmitted permanently via the signal interface 254, so that respectively current offer-related information 280 is available to the fuel cell control apparatus 208. Via the offer-related information 280, which includes the mass flow jM, thus how much air the compressor arrangement 250 can deliver in what time, thus per unit time, for example per second, the fuel cell control apparatus 208 can carry out feedback-control of the fuel cell assembly 210, because a requirement based on the offer-related information 280 can be present by way of the communicated offer-related information 280.

By way of the buffer period PZ, the control apparatus sends information which represents the feedback-control of the compressor arrangement 250 in a wear-optimized time. The offer-related function is artificially modified in favor of the compressor service live by way of the buffer period PZ. For example, the offer-related information 280 can include that an absolute value increased by 0.5 bar is suppliable as an achievable pressure ratio rP with an additional mass flow jM of 20 g/s as achievable mass flow jM in a period of 0.8 s as the feedback-control period DT, wherein a part of the feedback-control period DT of 0.8 s is the buffer period PZ, and the compressor arrangement 250 is able to be feedback-controlled with greater wear without or with a shorter buffer period PZ and thus a shorter feedback-control period DT according to the offer-related information 280. The fuel cell control apparatus 208 can further process the offer-related information 280 for the predictive feedback-control of the fuel cell system 205, wherein the offer-related information 280 of the compressor arrangement 250 can be considered the upper limit.

FIG. 2 schematically shows a map 253 having an operating point 260 and an offer-related point 270 for operating a compressor arrangement 250 according to an aspect of the disclosure. A map 253 of this type is stored in a control apparatus 251 of the compressor arrangement 250. A control apparatus 251 of this type and a compressor arrangement 250 of this type are described with reference to FIG. 1. FIG. 2 will be described with reference to FIG. 1.

The map 253 here is illustrated as an area. The map 253 is a function of the pressure ratio rP and of the performance variable W, or the mass flow jM of the air flow 211, respectively. The pressure ratio rP is the ratio of the pressure of the air 255 to be drawn in and the pressure of the air flow 211. The map 253 shows a correlation between the pressure ratio rP and the performance variable W, or the mass flow jM, respectively, as a function of a rotating speed N. Each rotating speed N results in a curve in the map 253, which describes a correlation between the pressure ratio rP and the performance variable W. The map 253 is a function of the temperature T and of the barometric information P of the air to be drawn in.

At a given temperature T and barometric information P, an operating point 260 that lies in the map 253 is established during operation of the compressor arrangement 250. The operating point 260 is able to be defined by two of the following variables: the rotating speed N, the performance variable W, or the mass flow jM, respectively, and the pressure ratio rP.

The map 253 is delimited on the left, thus at a given rotating speed N, by a minimum performance variable W, by the so-called pump limit P. The map 253 is delimited on the right, thus at a given rotating speed N, by a maximum performance variable W, by the so-called choke line. Furthermore, the map 253 is delimited by a maximum rotating speed N.

Furthermore illustrated in FIG. 2 are two offer-related points 270. One of the offer-related points 270 (left) is an operating point 260 with a maximum pressure ratio rP. There is a pressure ratio difference DrP between the offer-related point 270 and the operating point 260. Another of the offer-related points 270 (right) is an operating point 260 with a maximum mass flow jM, or a maximum performance variable W, respectively. There is a performance variable difference DW between the offer-related point 270 and the operating point 260. The offer-related points 270 on the map 253 here are connected by a line and are based on the same rotating speed N. In this way, the rotating speed N is a rotating speed relating to the offer-related points 270. There is a rotating speed difference DN between the rotating speed N at the operating point 260 and the rotating speed N at the offer-related point 270.

The differences, thus the pressure ratio difference Drp, the performance variable difference DW and the rotating speed difference DN can be included in the offer-related information 280 in order to indicate the feedback-control reserve of the compressor arrangement 250. The offer-related information 280 includes a feedback-control period DT which relates to the pressure ratio difference Drp, the performance variable difference DW and/or the rotating speed difference DN and which is required in order to actuate the offer-related point 270 proceeding from the operating point 260.

FIG. 3 schematically shows a flow chart of a method 100 according to an aspect of the disclosure. The method 100 is a method 100 for a compressor arrangement 250 for a vehicle 200a, 200b. A compressor arrangement 250 of this type and a vehicle 200a, 200b of this type are described with reference to FIG. 1. FIG. 3 will be described with reference to FIGS. 1 and 2.

The method 100 includes: detecting 110 a temperature T of air 255 to be compressed and barometric information P relating to the air 255 and a rotating speed N of the compressor arrangement 250 and a performance variable W of the compressor arrangement 250. The detecting 110 thus corresponds to data detection or data input. In the process, the temperature T, the height above sea level, or directly an air pressure, as the barometric variable P, a rotating speed N as an actual rotating speed and the performance variable W are detected.

Determining 120 an operating point 260 takes place as a function of the rotating speed N and/or of the performance variable W. Processing the detected data takes place in order to determine the operating point 260 in the map 253 (see FIG. 2) of the compressor arrangement 250.

Determining 130 an offer-related point 270 takes place as a function of the operating point 260, of the temperature T and of the barometric information P. Determining 130 the offer-related point 270 takes place via a map 253 of the compressor arrangement 250. For this purpose, a maximum mass flow jM and a pressure ratio rP at a given rotating speed N are determined.

Determining 130 the offer-related point 270 takes place based on the current electric power consumption as a performance variable W of the inverter and the spacing. An electric output, which is required for achieving the offer-related point 270 and is compared with the current performance variable W, is calculated by way of the temperature T and the barometric information P, for example the height of the vehicle. This results in a difference which can be used as a control output as long as the maximum inverter performance is not exceeded.

Ascertaining 135 a feedback-control period DT takes place as a function of the operating point 260 and of the offer-related point 270. In the process, a mass inertia, or a momentum of inertia, is taken into account here via mechanical variables such as based on the rotor mass, wherein the mass may be parametrized, so as to ascertain conjointly with a volumetric flow or mass flow jM and a pressure and/or pressure ratio rP.

Ascertaining 140 offer-related information 280 takes place as a function of the operating point 260 and of the offer-related point 270. The offer-related information 280 has a mass flow jM achievable at the offer-related point 270 and/or a pressure ratio rP achievable at the offer-related point 270. The offer-related information 280 is ascertained as a function of a rotating speed difference DN and/or a performance variable difference DW. The offer-related information 280 includes the feedback-control period DT which indicates how long the compressor arrangement 250 requires in order to move to the offer-related point 270, for example as the point with the maximum pressure ratio rP and/or the maximum mass flow jM. The feedback-control period DT includes a buffer period PZ. The buffer period PZ is a function of an operating variable BI and/or operating temperature BT of the compressor arrangement 250. The offer-related information 280 is ascertained while taking into account a buffer factor F.

Outputting 150 the offer-related information 280 takes place. The offer-related information 280 is outputted in order to be able to process the offer-related information 280 in the fuel cell control apparatus 208.

It is understood that the foregoing description is that of the preferred embodiments of the invention and that various changes and modifications may be made thereto without departing from the spirit and scope of the invention as defined in the appended claims.

### LIST OF REFERENCE SIGNS

### Part of the Description

65 Electric energy
100 Method
110 Detecting
120 Determining an operating point
130 Determining an offer-related point
135 Determining a feedback-control period
140 Determining offer-related information
150 Outputting
200a Vehicle
200b Commercial vehicle
205 Fuel cell system
206 Energy storage device
207 Electric drive
208 Fuel cell control apparatus
210 Fuel cell assembly
211 Air flow
250 Compressor arrangement
253 Map
251 Control apparatus
254 Signal interface
255 Air
260 Operating point
270 Offer-related point
280 Offer-related information
BI Operating variable
BT Operating temperature
DN Rotating speed difference
DrP Pressure ratio difference
DW Performance variable difference
jM Mass flow
F Buffer factor
N Rotating speed
P Barometric information
PZ Buffer period
rP Pressure ratio
T Temperature
W Performance variable

1. A method for a compressor arrangement for a vehicle, the method comprising:
detecting a temperature of air to be compressed and barometric information relating to the air and a rotating speed of the compressor arrangement and a performance variable of the compressor arrangement;
determining an operating point as a function of at least one of the rotating speed and the performance variable;
determining an offer-related point adjustable as a potential operating point as a function of the operating point, of the temperature and of the barometric information;
ascertaining offer-related information as a function of the operating point and of the offer-related point; and
outputting the offer-related information.

2. The method of claim 1, wherein the offer-related information has at least one of a mass flow achievable at the offer-related point, a pressure ratio achievable at the offer-related point and the rotating speed relating to the offer-related point.

3. The method of claim 1, wherein said determining the offer-related point takes place via a map of the compressor arrangement.

4. The method of claim 1, wherein the offer-related information is ascertained as a function of at least one of a rotating speed difference and a performance variable difference.

5. The method of claim 1 further comprising:
ascertaining a feedback-control period as a function of the operating point and of the offer-related point; and,
wherein the offer-related information includes the feedback-control period.

6. The method of claim 5, wherein the feedback-control period includes a buffer period.

7. The method of claim 6, wherein the buffer period is a function of at least one of an operating variable and an operating temperature of the compressor arrangement.

8. The method of claim 1, wherein the offer-related information is ascertained while taking into account a buffer factor.

9. The method of claim 1, wherein the vehicle includes a fuel cell assembly and the compressor arrangement is configured to impinge the fuel cell assembly with an air flow.

10. The method of claim 1, wherein the vehicle is a commercial vehicle.

11. A computer program comprising program code which, when the program code is executed by a computer, causes the computer to perform the method of claim 1.

12. A computer-readable medium comprising commands which, when the commands are executed by a computer, causes the computer to perform the method of claim 1.

13. A control apparatus for a compressor arrangement for a vehicle, wherein the control apparatus is configured to carry out the method of claim 1 and has a signal interface for outputting the offer-related information.

14. The control apparatus of claim 13, wherein the vehicle is a commercial vehicle.

15. A compressor arrangement for a vehicle, the compressor arrangement comprising:
a control apparatus having a signal interface;
said control apparatus being configured to:
detect a temperature of air to be compressed and barometric information relating to the air and a rotating speed of the compressor arrangement and a performance variable of the compressor arrangement;
determine an operating point as a function of at least one of the rotating speed and the performance variable;
determine an offer-related point adjustable as a potential operating point as a function of the operating point, of the temperature and of the barometric information;
ascertain offer-related information as a function of the operating point and of the offer-related point; and,
wherein said signal interface is configured to output the offer-related information.

16. A fuel cell system for a vehicle comprising:
a compressor arrangement including a control apparatus having a signal interface;
said control apparatus being configured to:
detect a temperature of air to be compressed and barometric information relating to the air and a rotating speed of the compressor arrangement and a performance variable of the compressor arrangement;
determine an operating point as a function of at least one of the rotating speed and the performance variable;
determine an offer-related point adjustable as a potential operating point as a function of the operating point, of the temperature and of the barometric information;
ascertain offer-related information as a function of the operating point and of the offer-related point;
said signal interface being configured to output the offer-related information;
a fuel cell control apparatus;
a fuel cell assembly;
said compressor arrangement being configured to impinge said fuel cell assembly with an air flow; and,
said signal interface being configured to output the offer-related information to said fuel cell control apparatus.

17. A vehicle comprising the compressor arrangement of claim 15.

18. The vehicle of claim 17, wherein the vehicle is a commercial vehicle.

19. A vehicle comprising the fuel cell system of claim 16.

20. The vehicle of claim 19, wherein the vehicle is a commercial vehicle.
